(19) United States
(12) Patent Application Publication
(10) Pub. No.: US 2002/0103832 A1
(43) Pub. Date: Aug. 1, 2002

(54) METHOD OF TRANSMITTING DATA AND METHOD OF AND APPARATUS FOR DISPLAYING DATA

(76) Inventor: ROY HOWARTH, CHESHIRE (GB)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 08/913,866

(22) PCT Filed: Mar. 7, 1996
(86) PCT No.: PCT/GB96/00526

(30) Foreign Application Priority Data
Mar. 7, 1995 (GB) 9504520.9

(51) Int. Cl. G06F 15/00

(52) U.S. Cl. 707/526

(57) ABSTRACT

Sending complex graphics to personal communication devices conventionally occupies valuable transmission time since the entire page description has to be sent whenever a display page has to be described or updated. This invention teaches storing those graphics in the memory of the device. A much shorter code, identifying database locations, can be sent as the data defining a page to be displayed and the relevant display page constructed, when selected by a user for display, by calling up the graphical elements from those locations in the memory. By embedding references to already stored graphics in the data transmission, substantial flexibility and air time economy is achieved.

### FIELD OF THE INVENTION

This invention relates to a method of transmitting data and a method of and apparatus for displaying data, particularly of graphical data broadcast to a message receiving apparatus, such as a receiver for pager transmissions, to enable pages constructed using graphical elements to be displayed on a visual display screen of the message receiving apparatus.

### DESCRIPTION OF THE PRIOR ART

There are various established approaches to transmitting and receiving data, particularly data that either forms or can be processed to lead to the display of images on a screen. For example, the techniques for transmitting data over computer networks form established and wide-ranging fields. Likewise, pager, television and Teletext transmission are broad and ever-developing areas. One characteristic of all such conventional approaches is that the final image that is displayed on a user's receiving unit, for example a television set, is generated directly from the received data: namely, the transmitted/received data directly determines which screen elements, such as pixels or phosphor dots, are “on” or “off”. The image perceived by a user is built up of the pattern of such screen elements. One exception to this is with characters. There are a number of different codes, developed in the computer field, which define the shape of a character to be displayed in terms of binary codes. Hence, ASCII defines codes for all commonly used characters. A document in ASCII can be transmitted over a computer, telephone or broadcast network and the original characters displayed at the receiving terminal if the ASCII is de-coded. In addition, page description languages, such as Postscript are well known in the computing fields and are useful as a standardised format for describing the layout, font styles, etc. of text and graphics images.

### STATEMENT OF THE INVENTION

In a first aspect of the invention, a method of transmitting data, to enable pages constructed using graphical elements to be displayed on a visual display screen of a message receiving device, comprises the steps of:

transmitting data defining those graphical elements to pre-determined address locations in a memory of the message receiving device and subsequently

transmitting data defining a page to be displayed, that data including some of those address locations for at least some of the graphical elements out of which the page is constructed.

By storing what may be complex graphics in various locations in a memory store, there is no longer any need to occupy valuable transmission time sending them whenever a display page has to be described or updated by sending the entire page description on a pixel by pixel basis, for example. Instead, a much shorter code, identifying database locations, can be sent as the data defining a page to be displayed and the relevant display page constructed, when selected by a user for display, by calling up the graphical elements from those locations in the memory. By embedding references to already stored graphics in the data transmission, substantial flexibility and air time economy is achieved.

In a preferred embodiment, the graphical elements are commonly used graphical icons or page layout formats. The receiving device, typically a pager receiver, may contain a number of databases which are regularly updated by the transmitter transmitting broadcast data defining database locations and descriptions of graphical elements to be associated with those locations. Generally, the pager will be able to display a number of different information categories and not merely display messages. Typical categories would be news, sport, weather, stock exchange and currency information; each category may then be served by a particular database. The user is able to navigate between display pages associated with each category by conventional navigation techniques, for example selecting menu items. When a user requires a particular page to be displayed on his pager, for example, the page showing the latest weather, then the receiving device retrieves those graphical elements from the relevant part of one or more databases that stores the data describing the page with the latest weather. Icons of commonly used weather symbols may be stored in one part of the database; page layouts corresponding to weather chart formats may be stored in another part. The receiving device then re-assembles the required weather page by extracting from the relevant databases the necessary graphical elements, finally displaying the required weather page on the screen.

In addition, it is not only entire pages that can be described for transmission, receipt by a receiver, re-assembly and display in accordance with this invention, but also parts of pages as well. The term ‘pages’ used in this specification therefore includes not just entire pages but parts of pages.

The information provider will often have an idea of how it wishes the pages of data to look. e.g. page layout (e.g. column numbers and types, tables, positioning of graphical icons amongst others) and typefaces etc. This requires a flexible system, since different pages of data will preferably be given different appearances. For example, a page showing entertainment events, e.g. films and television, may be treated very differently from a page with serious news. The present invention allows such flexibility since a variety of different page layout formats, typefaces etc. can be stored in memory and utilised as needed for different pages of data. This is a significant advance over earlier systems such as Teletext, where there is a single, very basic page layout which all pages must conform too.

Typically, each database can be hierarchically described in terms of pages and each page described in terms of fields within a page. Preferably, fields can be described in terms of rows and column locations.

In another aspect, a method of displaying pages incorporating graphical elements on a visual display screen of a receiving device for receiving messages, comprises the steps of:

transmitting, from a transmitter remote from the receiving device, data defining various graphical elements that those pages are constructed from;

receiving those various elements at the receiving device and storing them in a memory store at locations in dependence on address information in the transmitted data;

selecting a page from a selection of pages indicated as available on the visual display screen of the receiving device;

retrieving predetermined graphical elements from the memory store to form graphical elements of the selected page;

displaying on the visual display screen the selected page incorporating the pre-determined graphical elements.

In another aspect, message receiving apparatus adapted to display pages incorporating graphical elements on a visual display screen, comprises:

a receiver for receiving data sent from a transmitter remote from the apparatus, the data defining various graphical elements that pages to be displayed are constructed from;

a memory to store those various graphical elements at locations in dependence on address information in the data;

a processor adapted to retrieve pre-determined graphical elements from the memory and to display on the visual display screen a page, selected from a selection of pages indicated as available on the visual display screen, incorporating the pre-determined graphical elements.

### DETAILED DESCRIPTION

This description relates to an implementation of the invention in a pager. The following sections describe the ‘view’ of the pager database system used for transmission and reception of data. This system allows attractive, flexible display types and provides for the data manipulation capabilities required to maintain the data storage system, both of which are controlled—to a large degree—by the service provider.

The present invention provides a means for the service provider to transmit to Database (Logical) Pages, which are quite different than the actual visual pages the end user sees, using data references to various pre-stored graphical elements, rather than the actual graphical elements themselves. This enables quite complex graphical icons as well as fixed and consistent layouts to be used without excessive airtime useage. The software in the pager is responsible for extracting from memory the actual graphical elements and for ensuring that the on-screen pages include the necessary graphical elements as required.

### DATABASE ORGANISATION

In one embodiment, the basic scheme allows 96 Databases, each of which can contain up to 9216 Pages (these values will be explained later). Some of these database have pre-defined structure and functionality though they use database handling type features which can be used in general. Each page of a database is addressed in terms of fields via row and column references, the use of which will become clear when example database types are described later. These row/column references are contained within the message data.

The first page (Page 0) of each database is used to store special information relating to that database. For example, CELL type databases (see below) contain a lookup table of database/page references for each selection square.

The last two of the 96 databases are allocated for general ‘library’ use. These are databases in their own right but are referenced by other databases to reduce air-time. As an example, database 94 is the Word Library, each page of which contains a word or phrase, updated by the service provider just as any other database. Now, rather than transmitting an entire word, a control code references the appropriate page (i.e. word or phrase) which is subsequently replaced for display.

Pages (or records) are used to separate the main types of data elements within a database to enable simple, convenient referencing. For example, the General News (see later) considers each story as a separate component, each one being stored in its own page. Entire pages can be deleted/replaced and new ones automatically created if a message to a non-existent page is specified.

### PAGE DISPLAY/HANDLING

Following on from the News example above, the page display task simply cycles through the existing pages formatting each story as appropriate. Using page management type instructions within messages enables the service provider to control which ‘stories’ should be kept/updated/removed without the need for complex re-shuffling of text type elements within a page. Further, the general formatting and extent of the data can be largely controlled by the service provider (given the format control instructions that can be embedded) rather than having to pre-decide on the maximum number of stories etc. only to realise later that more is needed.

It is possible to display different styles of data on the display—e.g. simple text and tabular on same screen. This type of capability is made possible by formatting pages with appropriate embedded references to pre-transmitted Table definitions (see below) and other display type control functions. This level of sophistication affords a situation whereby the service provider does not have to commit itself to ‘hard-coded’ layouts and new databases can be added readily to the service which look attractive to the end user.

Certain display type related functions (e.g. a ‘More>’ icon at the bottom of the display indicative of further data) will be implemented by the pager's general handling software. This type of approach should simplify the service providers' task who will basically consider data in a virtual sense. In addition, the actual ‘line-breaks’ and final visual appearance of pages will be governed by the pager's display functions. This arrangement provides the correct balance between the service provider being able control the general format and appearance—allowing emphasis where required—without having to be concerned with the difficult details of actual display characteristics.

### DATABASE USAGE/EXAMPLES

Currently, the database numbers are allocated as follows:-

| | |
|---|---|
| 0 | Main Menu/Demonstration data |
| 1 | Personal Messages |
| 2 | Weather |
| 3 | Travel |
| 4 | Sport |
| 5 | General News |
| 6 | Shares |
| 7 | City News |
| 8 | TV Listings |
| 9 | Special Group |
| 10 | Exchange Rates |
| 11-82 | Spare |
| 83-93 | Special Group |
| 94 | Word Library |
| 95 | Table (forms) Library |

### OVERNIGHT MAINTENANCE/DATA SYNCHRONICITY

Overnight maintenance will be used to refresh databases containing long lists of data with minor ‘fields’ updated during daytime transmissions. Clearly however, there is a potential for invalid data being attributed to the wrong row/column—an example of this would be an incorrect share value against a company name.

To avoid this situation a ‘version number’ for the data within a database can be stored after an overnight refresh session. This is a part of the standard page 0 data for all databases. Messages containing part data may then use a ‘check version’ instruction that forces a comparison between the number in the check version instruction and that previously stored in page 0. If for whatever reason, the version numbers differ, the data is rejected or ‘flagged’ (highlighted on display).

Once again, the exact use of this version check facility can be decided by the service provider, used when they consider the data is sensitive to this type of synchronicity problem. Unless the messages contain this check version instruction, it will be dealt with as normal. This is the sensible default because most of the time, the data would not require this mechanism (e.g. General News).

### WORD LIBRARY

Database 94 is used as a word library enabling the substitution of up to 9120 commonly used words or phrases. The word Library feature is exemplifies one aspect of the present invention. Two methods of use are provided:-

i. A three character control sequence can reference up to 95 different words.

ii. A four character control expands this to 9120 words.

The library will probably be updated as an overnight maintenance task. A word or phrase will be contained on each page (except page 0). The page number is subsequently used as the reference to the word or phrase to be replaced within the data message.

Obviously, the service provider will maintain the contents of this library who will define it as and when they require to best suit the type of data being transmitted.

### TABLE LIBRARY

Database 95 is reserved for table definitions—a table per page containing the proportions of each column considered as a percentage of the overall width and column style instructions. As with the Word Library, the Table Library feature exemplifies one aspect of the present invention. Two methods of access are available providing access to 95 or 9120 table formats depending on the length of the control sequence used.

The table is ‘used’ by including a ‘start tabular’ instruction within the message. Each ‘row’ containing this instruction will be formatted into the table, each column spaced appropriately. This table fitting will continue for every line containing a ‘call’ to the table. Alternatively start/end table formatting instruction can be used to indicate several rows to be tabulated which reduces the air-time required to transmit the associated instructions.

### ICON LIBRARY

Icons are pre-defined in the pager, accessed by an appropriate Control Code within a data message. This feature again exemplifies an aspect of the present invention.

### CONTROL CODES AND DATABASE FORMATS

There are two main aims of this section:-

i. To describe how to control the general appearance of the data that will ultimately be displayed on the pager screen using data format commands.

ii. To explain how to maintain the data within the databases. This involves the basic structure of data storage within the databases and how the different elements of a database are referenced.

Basic Message Format

Each database type message contains up to 80 bytes and is of the following format:-

| Byte Offset | Usage |
|---|---|
| 0 | Database number transmitted as an ASCII character in the |
| | range 32 to 127. |
| 1 | Page number in the range 0-95. |
| 2 | Row number in the range 0-95. |
| 3-n | Message data. |

The binary value for the database is found by subtracting the ASCII bias of 32 from that transmitted, thus allowing 96 (0-95) databases to be addressed.

An initial page and row number are specified, though these are both restricted to the a range of 0-95. In the majority of cases, this range will probably be sufficient, thus saving on page and row control instructions. Of course, the row and page can be changed in the normal way by the use of row and page addressing control instructions.

Field Access

As described earlier, each page of a database can be accessed in terms of fields. The pre-defined databases require (i.e. the internal software expects) certain field layouts to be adhered to. However, this fixing of format has been kept to a minimum so as to enable the service provider to control the appearance where possible.

The control of these field layouts is handled by the use of row and column instructions contained in data messages. As described later, all control instructions are pre-fixed by the carat (ˆ ) character, followed by one or more characters which define the type of instruction and provide additional parameters when required.

In addition to the database and page number, a lot of data messages will require at least one of these row/column instructions. There are two families of row/column instructions characterised by the ‘range’ of pages they can address:-

| Code | Command |
|---|---|
| ^{Λ}f[column][row] | This is used to replace the contents of a field-the original data |
| | in the field (if it existed at all) are replaced by the data following |
| | this instruction. A full field reference ([column] and [row]) is |
| | supplied, each of which is a single character, transmitted as |
| | ASCII. The actual row and column values are found by |
| | subtracting 32 in the same fashion as the database number, |
| | allowing row/column ranges of 0-95. |
| \hat{ }r[row] | This allows just the [row] to be specified, the column is assumed to be 0. |
| | This instruction is useful when simple lines of data are being used |
| | (e.g. NEWS data). If the specified row |
| | contains only one field (i.e. it is a line), then the line is replaced |
| | with the data following the instruction. If more than one |
| | column exists, then just column 0 is replaced, all other columns |
| | are unaffected. |
| \hat{ }F[column][row] | This instructions is the same as the (\hat{ }f) instruction except that |
| | [column] and [row] are each supplied with two-character |
| | values using the base 96 representation. This allows row and |
| | column references in the range 0-9215. However, wherever |
| | possible the (\hat{ }f) instruction should be used as it clearly |
| | requires fewer characters. |
| \hat{ }R[row] | This is the two-character version of the (\hat{ }r) instruction |
| | described above. Once again, the (\hat{ }r) instruction would be |
| | used in favour of this base 96 equivalent. |
| \hat{ }s | This instruction is used to skip to next column-whether it |
| | currently exists or not. Note that this is a column skip for |
| | logical pages ONLY and does not affect the visual appearance |
| | directly. |
| \hat{ }S[columns] | Behaves as the (\hat{ }s) instruction but allows a number of columns |
| | to be skipped to be specified-single character in the range 32- |
| | 127. There is no base 96 equivalent. |

Each of the following examples assumes that the database and page number have already been supplied as the first three bytes of the message as is ALWAYS required.

ˆ f″$Roadworksˆ f#$Latest Reports . . . ˆ Z

The above example replaces the existing contents of the field whose ‘address’ is column 2, row 4 (i.e. field[2,4]) with the string “Roadworks” and the field[3,4] with the string “Latest Reports . . . ”. The ˆ Z instruction (explained later) is a general message terminator.

ˆ f14ˆ f′4ˆ r5More prices to followˆ Z

In this case, field[1,20] and field[2,20] are ‘deleted’ (i.e. replaced with nothing), line 21 (i.e. field[0,21]) is replaced with the string “More prices to follow”.

Note that the data used in the replace operation is everything (including control instructions) up to the ‘next’ field type instruction (ˆ f, ˆ r, ˆ F, ˆ R, ˆ s or ˆ S) or the end of message instruction (ˆ Z). The following example demonstrates this:-

ˆ FDNAB will be ˆ bFREEˆ b todayˆ Z

Firstly, in the above example, the ˆ b instructions is used to enclose a string to be displayed in bold type—i.e. it marks the start and end. The ˆ F instructions—which has the four characters as its parameters—is a bit of handful but is considered as follows.

Firstly, individually the characters “DNAB” lead to the following values (having subtracted the usual 32 ASCII bias):-

D=36 (dec), 24 (hex), 0100100 (bin)

N=46 (dec), 2E (hex), 010110 (bin)

A=33 (dec), 21 (hex), 0100001 (bin)

B=34 (dec), 22 (hex), 0100010 (bin)

Now, DN are the column reference and ˆ B represent the row. Thus,

column=36+(46*96)=4452 (decimal)

row=33+(34*96)=3297 (decimal)

Overall therefore, the instruction replaces the data in field(4452, 3297) with the string “will be ˆ bFREEˆ b today”. Ultimately, this will be displayed with the “FREE” in bold:-

will be FREE today

Using the Word Library

As explained earlier, database 94 is used as a general word/phrase library. To make use of this library, the required words and phrases are transmitted to database 94. Once they exist here, in the appropriate format, they can be ‘called’ by any message. There are two instruction methods to retrieve a word from the library:-

| Code | Command |
|---|---|
| \hat{ }w[wpage] | This instruction allows up to 95 different words from the |
| | library to be used. As will be explained later, |
| | this retrieves the first word of each of the possible 95 (0 is reserved) pages of |
| | the word library database. This method uses three characters to |
| | retrieve the required word from the library. |
| \hat{ }W[wpage][wrow] | In theory, this allows up to (95 * 96) = 9120 words but |
| | requires four characters to retrieve one word. |

How the Word Library Operates

The word library uses the page and row addressing to reference the required words. The ˆ w instruction retrieves the first word (i.e. that contained in row 0) of each page—page 0 is reserved and therefore no words are stored here. Thus, only a single character is needed to represent the word number (1-95), with the usual 32 bias subtracted.

The ˆ W instruction simply uses another character enabling both a page and row to be referenced. Row 0 is considered to be valid here so the range 0-95 can be used, thus this allows 95*96 words to be addressed.

These instructions are basically ‘shortcut’ methods of accessing database 94 (for reading data back only). Note that no such shortcut commands exist to write to database 94 in this way. The r instruction MUST be used to stored the words or phrases in the word library in the first place (the ˆ f instruction can also be used but that would require one more character per word).

Note that it is possible to store ‘several’ words in the same page with a single message—simply separate the words with the ˆ r instruction. Consider the following two example messages:-

˜$ ˆ r dataˆ r!databaseˆ r″dealingˆ Z

˜% ˆ r editˆ r!educationˆ Z

In the first message, the ˜ represents database number 94 (character code 126-32). This is followed by base 96 page number ($). There are then three row control commands which results in the following words in page 4:-

| Row | Word |
|---|---|
| 0 | data |
| 1 | database |
| 2 | dealing |

The second message specifies two word for page 5:-

| Row | Word |
|---|---|
| 0 | edit |
| 1 | education |

A similar construct can be used to store word on different pages by including ˆ p (goto page) instructions. Note however, that each word that is retrieved by the ˆ w instruction is always in row 0 of the specified page (i.e. wpage).

As an example of word retrieval, the following message (extract):-

ˆ W$ ˆ w$ˆ w% ˆ W%!ˆ Z

retrieves the words: datadataedit education

Note here where the space character is a ‘value’ and when it is actually behaving as a space character.

Using the Table Library

The organisation of the Table Library is identical to the Word Library in terms of how each table is stored and retrieved. Instead of a ˆ w there is a corresponding ˆ t instruction which can retrieve up to 95 different table formats. Similarly, a ˆ T instruction allows 9120 different tables to be used:-

| Code | Command | | |
|---|---|---|---|
| \hat{ }t[rpage] | The table [tpage] will be used in conjunction with the data | | |
| | following this instruction to ‘draw’ a tabular display including | | |
| | separating rules etc. Each ‘column’ is separated by a jump to | | |
| | next column (\hat{ }c) instruction. Note that this has NOTHING to | | |
| | do with the row/column manipulation as described earlier. This | | |
| | instruction is concerned with ‘screen formatting] and NOT how | | |
| | the data will be ‘stored’. Although this type of table formatting | | |
| | requires a relatively large number of control instructions, it's | | |
| | useful to format the rows of tables which are different from line | | |
| | to line. | | |
| | The following example demonstrates the use of this feature | | |
| | showing that text does not have to be contained with database | | |
| | columns to be tabulated:- | | |
| | \hat{ }t9\hat{ }bCode\hat{ }cMeaning\hat{ }cDescription\hat{ }b | | |
| | \hat{ }t9\hat{ }e | | |
| | \hat{ }901\hat{ }cCLEAR\hat{ }cClear Display | | |
| | \hat{ }t9O2\hat{ }cHOME\hat{ }cCursor Home | | |
| | This will tabulate as:- | | |
| | Code | Meaning | Description |
| | 01 | CLEAR | Clear Display |
| | 02 | HOME | Cursor Home |

| | Note that rules will be drawn according to table style and that | | |
|---|---|---|---|
| | the bold/normal typeface change could also have been specified within the table definition. | | |
| | Note also the (\hat{ }t9\hat{ }e) construct | | |
| | which calls table number 25, but ends table formatting (via \hat{ }e | | |
| | instruction) which results in a blank line. This blank line could | | |
| | have been generated as normal (\hat{ }n). | | |
| | It may sometimes be convenient to store the data corresponding | | |
| | to each ‘visual column’ in separate fieldr within a page. Each | | |
| | field could then be pre-fixed by a (\hat{ }c) instruction (see below). | | |
| | In any event, there is a similar control instruction to format in a | | |
| | tabulated fashion using logical page columns as separators. | | |
| \hat{ }T[tpage][trow] | As with the word library, this provides a method of accessing | | |
| | pre-defined tables in terms of a page and row reference. In | | |
| | every other way, it behaves as the (\hat{ }t) instruction. | | |
| \hat{ }x[tpage] | This instruction starts tabular formatting using the specified | | |
| | table until the next occurrence of the instruction (excluding the | | |
| | table reference). In this case, column separators are not | | |
| | required-it assumes that the fields of each row in a page | | |
| | correspond to the tabular columns. If more fields exist than | | |
| | there are columns, then the tabular row is truncated to the | | |
| | number of columns defined in the table. The example table as | | |
| | above using this instrucdon could be achieved as follows: | | |
| | \hat{ }x9\hat{ }bCode Meaning Description\hat{ }b\hat{ }n | | |
| | 01 | CLEAR | Clear Display |
| | 02 | HOME | Cursor Home |

| | |
|---|---|
| | \hat{ }; |
| | Note here that the ‘space’ represent that each element is stored |
| | in a separate column (field) within each row. The final visual |
| | appearance will be the same as the earlier (\hat{ }t) example. |
| \hat{ }X[tpage][trow] | This is the extended version of the (\hat{ }x) tabular instruction |
| | allowing 9120 tables to be addressed. It behaves in an identical |
| | fashion to the (\hat{ }x) instruction other than this. |

The definitions of these tables is very straight-forward. Each table is defined within a row of database 95, using afield for each column specification. This data is transmitted using the usual row and column instruction described earlier.

The first character of each field is a percentage of the total width of a display page for the column. After this, other instructions to control column alignment and typeface style can be included. Note that these style attributes will be effective only within the column they are specified in. The following example defines a table with four columns (once again, the separating spaces are used to indicate different fields within the row):-

Hˆ b *ˆ . Hˆ b *ˆ ]

The first column requires 40% of the screen width and text will appear bold. The second will default to normal type but will be decimal aligned, using 10% of the display width. Column three is identical to the first column. The final column will default to normal type, be flushed right (right aligned within column area) and use 10% of display width.

### DATABASE (LOGICAL) PAGE FORMATS

General use of Page 0

Page 0 of every database contains ‘global’ data for the handling of that database. The only exception to this is database 0 which uses page 0 differently. Each page zero contains the following:-

| Row | Data | | |
|---|---|---|---|
| 0 | At least one character in the range 32-127 representing the special | | |
| | handling of this database. Additional characters are used to serve as | | |
| | parameters for the special handling. The functionality of each | | |
| | type of handling is described later but the following are the basic | | |
| | special handling types: | | |
| | 32 | NONE | (e.g. Sports) |
| | 33 | PERSONAL | (Very special!) |
| | 34 | CELL | (e.g. Weather) |
| | 35 | PAGE COMBINE | (e.g. News) |
| | 36 | EXCHANGE | (e.g. Exchange rates) |
| | 37 | COLUMN COMBINE | (e.g. Shares) |
| | 126 | WORD LIBRARY | |
| | 127 | TABLE LIBRARY | |

| | |
|---|---|
| | A single character (32-127) used co represent |
| | the current version of the |
| | data within this database. This is used in conjunction with the |
| | overnight and version checked update procedure. |
| 2 | Should contain the main and sub-headings for this |
| | database. Control instructions are used to define these -e.g. |
| | \hat{ }(Exchage Rates\hat{ })Latest: \hat{ }L |
| | Only the first Main header will be used though |
| | as many sub-headers as |
| 5 | required can be included (the \hat{ }d is a date/time stamp i.e. will be |
| | replaced with the pager date/time). |

Database 0—Main Services Menu

Database 0 is always enabled (cannot be disabled by user). This contains the information to display in the main services page and various information required to ‘go’ to the actual database required. Additionally, demonstration/teaser data is stored in this database.

Pages 1 to 95 (in theory) contain data relating to each available service as follows:-

| Row | Data |
|---|---|
| | RESERVED. This row should not (cannot) be used by the service |
| | provider- it will be used to score user-configured information. |
| 1 | This is a two character (base 96 representation) reference |
| | of the ICON to be displayed in the selection box. |
| 2 | Text for the service selection box. This is limited to 11 characters. |
| 3 | May contain a two character (base 96 representation) reference to |
| | the ‘start’ page of the database. The default page will depend on |
| | the special handling type associated with the database. |
| | For example, CELL type will display the ‘map’ format by default, |
| | NONE (sport) will start at page 1. |

Pages 96-(whatever) contain demonstration/teaser data that will be used if this service is selected under the following circumstances:-

i. User is not subscribed to this service—i.e. not entitled.

ii. User is entitled but NO data in corresponding database.

iii. Factory RIC.

Basically, there is a one-to-one correspondence with the page number and the demonstration data for that page (i.e. data is contained on page+96).

Special Handling

The special handling reference contained in page 0 of each database is used to control the behaviour/visual appearance. There are a number of pre-defined special handling types, which although designed to cope with the fixed services, can be used by any ‘new’ database. These types are described below in terms of the format for the pages and any other special requirements.

34—CELL

This is designed to handle ‘grid’ type selection as used by the Weather and Travel services. Additional data is stored in page 0 to control the behaviour and selection of pages relating to each cell. Normally, the map (or whatever) is displayed with an 8 by 12 grid overlaid. A lookup table is stored in page 0, each ‘slot’ corresponding to each of the 96 available by selection on the grid. A number of different ‘levels’ of lookup table can also be used based on the selection of icons displayed at the top of the PDA700 screen—this level selection data is also stored in page 0.

In addition, the default page specification (row 3 of corresponding database 0 page) can be used to choose whether the ‘map’ display or normal type of page should be the default. If this is BLANK or specifies page 0, then the map and grid will be displayed and the cell type behaviour using the lookup table is used. Alternatively, a page containing ‘normal’ type controls (i.e. text, page links etc.) can be specified which will then be displayed as normal. A link to page 0 from any of the pages within this database will result in the map and grid being displayed.

Page 0 Layout

| Row | Data | |
|---|---|---|
| 0-2 | Standard page 0 information (i.e. type, version and headers). | |
| 3 | This contains the ‘map’(i.e. graphic displayed under grid) reference | |
| | -a single character in the range 32-27. The following are currently | |
| | defined: | |
| | 0 | UK |
| | 1 | FRENCH |
| | 2 | GERMAN |
| | 3 | ITALIAN |
| | 4 | SPANISH |

4 This contains references (ˆ i instructions) for the ‘level select’ icons to be displayed at the top of the screen—the first icon corresponds to the first level lookup table (see below). These icons can be selected by the user to select the basic information. The Travel database provides an example of this—e.g. Road, Rail or Air all contained on the ‘same’ database map display. The pages containing the information for each type will probably be held in the ‘same’ database though this is not absolutely necessary. Note however, that if the lookup table specifies a link to a page in another database then that page cannot link back to the map and grid display by using a page 0 reference.

5-16 Twelve rows corresponding to those on the display grid. Each row contains eight columns, creating a ‘slot’ for each selectable box on the grid display. Each slot can contain one or all of the following:-

i. Reference of icon to be displayed ‘in’ grid square.

ii. Link instruction (see control instructions) of the page relating to this cell.

iii. Any other text elements that are displayed ‘over’ the icon.

An example:-

ˆ i4ˆ gS

would display icon number 20 in the corresponding display cell and ‘go’ to page 51 if selected by the user.

When the user selects a square from the display grid, the corresponding cell in this lookup table is used to control the page to be selected. Clearly, cells can share pages and may also be BLANK—resulting in no action.

17 . . . There are 12 rows for each level to be supported via the grid selection process. Selection of the ‘level’ icons controls which specific lookup table will be used.

35—PAGE COMBINE

This type of handling is used by the News and City News pages. Each story is transmitted to a separate page but these are ‘combined’ on the pager display (separated by a rule). The display order of these stores can be controlled as described below. No extra information is required in page 0 but each page is assumed to contained the following:-

| Row | Data |
|---|---|
| 0 | Is expected to ‘contain’ a date/time stamp instruction (\hat{ }d) |
| | Note that this instruction is automatically replaced with the |
| | internal pager date/time. The stories are displayed, latest time first |
| | so this can be used by the service provider to control the order in |
| | which they appear. This row can be written to at any time of |
| | course, enabling ‘old’ stores to become important again |
| 1. . . | if required just by transmitting a (\hat{ }d) instruction. |
| | One or more rows containing the news story. The service provider |
| | can use the row mechanism to ‘edit’ sections of a story |
| | if required. All existing rows from this point in the page will |
| | be considered to be part of the story. |

36—EXCHANGE

This is used for the Exchange Rates service though may be of general use in conversion type databases.

| Row | Data |
|---|---|
| 0 | Used as the table header. |
| 1. . . | Each row contains two columns containing the ‘currency’ |
| | name and exchange factor-assumed to be compared against |
| | a factor of 1 (pound in this case). |

37—COLUMN COMBINE

This type of handling is used by the Shares database which combines the data from different logical pages into one visual display similar to page combine. However, in this case, each page of data is considered to consist of a number of columns which will be combined to a tabular display by a similar method to the ˆ x mechanism. In addition, this differs from the normal page combine in that no date is required for each page (ˆ d) as each page corresponds to the display order (i.e. page 1 will be display row 1).

Two table definitions (pre-defined though they can be changed) are used to control the tabulation of the column headings and main data These table styles do not have to contain the same number of columns as there are fields in each page of data—for the Shares data there are normally eight in each logical page but only three columns for the visual table.

Thus the number of displayed columns is limited by the table definitions. However, the user may select a row from the ‘browse’ page which will then be ‘expanded’ to show all of the columns (within logical page) in a pop-up window—yet another table definition is pre-stored to control this display.

Page 0 Layout

| Row | Data |
|---|---|
| 0-2 | Standard page 0 information (i.e. type, version and headers). |
| 3 | Assumed to contain the headers corresponding to |
| | each display column. |
| | These should be separated into different logical columns within this |
| | row- a typical transmitted message extract might be:- |
| | & #Stock\hat{ }sPrice\hat{ }sChange\hat{‘}Other |

Pages 1-n

| Row | Data |
|---|---|
| 0 | Each page contains a number of columns that will be used within |
| | the main body of the tabular display. A typical transmission to a |
| | page would be:- |
| | &! Amstrad\hat{ }s132.5\hat{ }s+0.5\hat{ }s250.0\hat{ }s126.0\hat{ }s41.4 |
| | The above messages creates/updates row 0 of page 1 with six fields |
| | of data. |

Table definitions

| Table | Usage |
|---|---|
| 22 | Used to format the column headers. |
| 23 | Controls the display of the main body of data for each row. |
| 24 | Normally contains two column definitions. Column 0 controls the |
| | attributes to be applied to the FULL list of column headers (see |
| | above page 0, row 0) whilst the second applies to the data for each |
| | column within selected row. |

1. A method of transmitting data, to enable pages constructed using graphical elements to be displayed on a visual display screen of a message receiving device, comprising the steps of:
transmitting data defining those graphical elements to pre-determined address locations in a memory of the message receiving device and subsequently
transmitting data defining a page to be displayed, that data including some of those address locations for at least some of the graphical elements out of which the page is constructed.

2. The method of claim 1 wherein the graphical elements are commonly used graphical icons or page layout formats.

3. The method of claim 1 or 2 wherein the receiving device contains a number of databases which are regularly updated by the transmitter transmitting broadcast data defining database locations and descriptions of graphical elements to be associated with those locations.

4. The method of claim 3 wherein the receiving device can display a number of different information categories and can display messages.

5. The method of claim 4 the information categories include news, sport, weather, stock exchange and currency information and each category is be served by a particular database.

6. The method of any preceding claim wherein a variety of different page layout formats and typefaces are stored in memory and utilised as needed for different pages of data.

7. A method of displaying pages incorporating graphical elements on a visual display screen of a receiving device for receiving messages, comprising the steps of:
transmitting, from a transmitter remote from the receiving device, data defining various graphical elements that those pages are constructed from;
receiving those various elements at the receiving device and storing them in a memory store at locations in dependence on address information in the transmitted data;
selecting a page from a selection of pages indicated as available on the visual display screen of the receiving device;
retrieving pre-determined graphical elements from the memory store to form graphical elements of the selected page;
displaying on the visual display screen the selected page incorporating the pre-determined graphical elements.

8. A message receiving apparatus adapted to display pages incorporating graphical elements on a visual display screen, comprising:
a receiver for receiving data sent from a transmitter remote from the apparatus, the data defining various graphical elements that pages to be displayed are constructed from;
a memory to store those various graphical elements at locations in dependence on address information in the data;
a processor adapted to retrieve pre-determined graphical elements from the memory and to display on the visual display screen a page, selected from a selection of pages indicated as available on the visual display screen, incorporating the pre-determined graphical elements.
